(19) United States
(12) Patent Application Publication
(10) Pub. No.: US 2014/0068387 A1
(43) Pub. Date: Mar. 6, 2014

(54) TRANSMITTING APPARATUS, RECEIVING APPARATUS, TRANSMITTING METHOD AND RECEIVING METHOD FOR COMMUNICATING DATA CODED WITH LOW DENSITY PARITY CHECK (LDPC) CODES

(71) Applicant: JVC KENWOOD Corporation, Yokohama-shi (JP)

(72) Inventors: Masafumi IWASA, Yamato-shi (JP); Shohei ODAN, Yokohama-shi (JP); Eiji NAKANO, Yokohama-shi (JP); Toru FUJIMOTO, Yokohama-shi (JP)

(73) Assignee: JVC KENWOOD Corporation, Yokohama-shi (JP)

(21) Appl. No.: 13/954,664

(22) Filed: Jul. 30, 2013

(30) Foreign Application Priority Data
Aug. 28, 2012 (JP) 2012-187734

(51) Int. Cl. H04L 1/00

(52) U.S. Cl. CPC H04L 1/004
USPC 714/776

(57) ABSTRACT

A low density parity check (LDPC) coding unit performs LDPC coding. An interleaving unit interleaves the LDPC-coded data, based on an array according to the number of bits that constitute a modulated symbol. A per-area division rearrangement unit divides to classify the interleaved data into a plurality of areas in a manner such that each area is formed by contiguous data and also outputs data, according to the number of bits that constitute the modulated symbol, by successively changing the areas. A symbol mapping unit generates the modulated symbol based on the data fed from the per-area division rearrangement unit.

### BACKGROUND OF THE INVENTION

1. Field of the Invention

The present invention relates to a communication technology, and it particularly relates to a transmitting apparatus, a receiving apparatus, a transmitting method, and a receiving method for communicating data coded with low density parity check (LDPC) codes.

2. Description of the Related Art

Attention has recently been focused on a low density parity check code (LDPC or LDPC code) as an error correcting code having a high error correction capability even in a low-S/N channel. The LDPC code has been applied in many fields. In LDPC, data is coded, at a transmission side, with a coding matrix generated based on a sparse check matrix. Here, the sparse check matrix is a matrix each element of which is “1” or “0” and where the number of 1's is small. On the other hand, at a receiving side, the data decoding and the parity checking are done based on the check matrix. In particular, the decoding performance is known to improve if an iterative decoding method such as a belief propagation (BP) method is used.

A method is being proposed where the code bits of LDPC are interleaved so that the mapping is done in a manner such that a code bit of LDPC susceptible to error is assigned to a weak bit or strong bit of a symbol of the quadrature modulation. As an application of such an interleaver, proposed is a method where the interleaving is done such that the related parity bits are not to be mapped on the same symbols (see Reference (1) in the following Related Art List, for instance). Also, a method is being proposed where the interleaving is done such that the element of each check node in the check matrix is not mapped onto the same symbol (see Reference (2), for instance).

2. Related Art List

(1) Pamphlet of International Patent Application No. WO 2009/069617.

(2) Pamphlet of International Patent Application No. WO 2009/069618.

In the case of an LDPC code coded using a parity check matrix that has a low density generation matrix (LDGM) structure, the parity bit parts having the same number of column weights suffer the loss of data all at once due to the fading, in those parity bit parts whose column weights are small and which are susceptible to error. Hence, the error correction capability deteriorates.

### SUMMARY OF THE INVENTION

The present invention has been made in view of the foregoing circumstances, and a purpose thereof is to provide a technology that ensures satisfactory characteristics under fading circumstances in LDPC codes coded with a parity check matrix having an LEGM structure.

In order to resolve the above-described problems, a transmitting apparatus according to one embodiment of the present invention includes: a low density parity check (LDPC) coding unit configured to perform LDPC coding; an interleaving unit configured to interleave data that has been LDPC-coded by the LDPC coding unit, based on an array according to the number of bits that constitute a modulated symbol; a per-area division rearrangement unit configured to divide the data, which has been interleaved by the interleaving unit, into a plurality of areas in a manner such that each area is formed by contiguous data and configured to output data, according to the number of bits that constitute the modulated symbol, by successively changing the areas; and a mapping unit configured to generate the modulated symbol based on the data fed from the per-area division rearrangement unit.

By employing this embodiment, the data is divided into a plurality of areas and then data is outputted according to the number of bits that constitute the modulated symbol, by successively changing the areas. Thus, satisfactory characteristics can be ensured under fading circumstances.

Another embodiment of the present invention relates to a receiving apparatus. The receiving apparatus includes: a receiver configured to receive a modulated symbol from a transmitting apparatus, wherein the transmitting apparatus (1) interleaves data on which low density parity check (LDPC) coding has been performed, based on an array according to the number of bits that constitute a modulated symbol, (2) divides the interleaved data into a plurality of areas in a manner such that each area is formed by contiguous data and outputs data, according to the number of bits that constitute the modulated symbol, by successively changing the areas, and (3) generates the modulated symbol based on the data outputted; a demapping unit configured to extract data from the modulated symbol received by the receiver; a per-area rearrangement combining unit configured to combine the data, which has been divided for each area, in a manner such that (i) a process, of dividing into a plurality of areas, performed in the transmitting apparatus and (ii) a process, of outputting the data by successively changing the areas, performed in the transmitting apparatus are performed on the data extracted by the demapping unit in a reverse order, respectively; a deinterleaving unit configured to deinterleave the data, fed from the per-area rearrangement combining unit, in response to interleaving performed by the transmitting apparatus; and an LDPC decoding unit configured to LDPC-decode the data that has been deinterleaved by the interleaving unit.

By employing this embodiment, the process of dividing the data into a plurality of areas in the transmitting apparatus and the process of outputting the data by successively changing the areas in the transmitting apparatus are reversed, respectively. Thus, the data can be divided into the plurality of areas and, at the same time, the data corresponding to the number of bits constituting the modulated symbol can be decoded by successively changing the areas.

Still another embodiment of the present invention relates to a transmitting method. The transmitting method includes: performing low density parity check (LDPC) coding; interleaving data that has been LDPC-coded, based on an array according to the number of bits that constitute a modulated symbol; dividing the interleaved data into a plurality of areas in a manner such that each area is formed by contiguous data and outputting data, according to the number of bits that constitute the modulated symbol, by successively changing the areas; and generating the modulated symbol based on the data outputted.

Still another embodiment of the present invention relates to a receiving method. The receiving method includes: receiving a modulated symbol from a transmitting apparatus, wherein the transmitting apparatus (1) interleaves data on which low density parity check (LDPC) coding has been performed, based on an array according to the number of bits that constitute a modulated symbol, (2) divides the interleaved data into a plurality of areas in a manner such that each area is formed by contiguous data and outputs data, according to the number of bits that constitute the modulated symbol, by successively changing the areas, and (3) generates the modulated symbol based on the data outputted; extracting data from the modulated symbol received; combining the data, which has been divided for each area, in a manner such that (i) a process, of dividing into a plurality of areas, performed in the transmitting apparatus and (ii) a process, of outputting the data by successively changing the areas, performed in the transmitting apparatus are performed on the extracted data in a reverse order, respectively; deinterleaving the combined data in response to interleaving performed by the transmitting apparatus; and performing LDPC-decoding on the interleaved data.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 shows a structure of a communication system according to an exemplary embodiment of the present invention;

FIG. 2 shows a check matrix used in an LDPC coding unit and an LDPC decoding unit shown in FIG. 1;

FIG. 3 shows a concrete example of a symbol mapping table in a symbol mapping unit of FIG. 1;

FIG. 4 shows an exemplary frequency of error occurrence for each bit, which constitutes a symbol, based on the symbol mapping table of FIG. 3;

FIG. 5 shows a concrete example of a bit-interleaved array structure in an interleaving unit of FIG. 1;

FIG. 6 shows areas defined by a per-area division rearrangement unit of FIG. 1;

FIG. 7 shows a concrete example of a rearrangement sequence table of FIG. 1;

FIG. 8 shows an outline of processing carried out by a per-area division rearrangement unit of FIG. 1;

FIG. 9 shows another outline of processing carried out by the per-area division rearrangement unit of FIG. 1;

FIG. 10 shows a result of simulation run in the communication system of FIG. 1; and

FIG. 11 is a flowchart showing a communication procedure done by the communication system of FIG. 1.

### DETAILED DESCRIPTION OF THE INVENTION

The invention will now be described by reference to the preferred embodiments. This does not intend to limit the scope of the present invention, but to exemplify the invention.

An outline of the present invention will be given before a specific description thereof. Exemplary embodiments of the present invention relate to a communication system including a transmitting apparatus and a receiving apparatus. Here, the transmitting apparatus performs LDPC coding, whereas the receiving apparatus iteratively decodes data, which has been coded by the transmitting apparatus (hereinafter referred to as “coded data” or “encoded data”), based on a check matrix. The transmitting apparatus prepares an array of data according to the number of bits that constitute a symbol in a manner such that the bits of LDPC susceptible to error can be assigned to the bits of modulated symbols susceptible to noise, and then the transmitting apparatus arranges the data in order. Then, the transmitting apparatus divides the array of data into a plurality of areas and sequentially reads out the data from the plurality of areas by changing the areas. Further, a symbol is generated by the thus read-out data. In this manner, the elements in the array of data are partitioned into areas and rearranged and then turned into symbols, so that the continuous transmission of parity bit parts having the same column weight can be avoided. This prevents the parity bit parts having the same column weight from being lost all together due to the fading, and therefore the error correction capability improves.

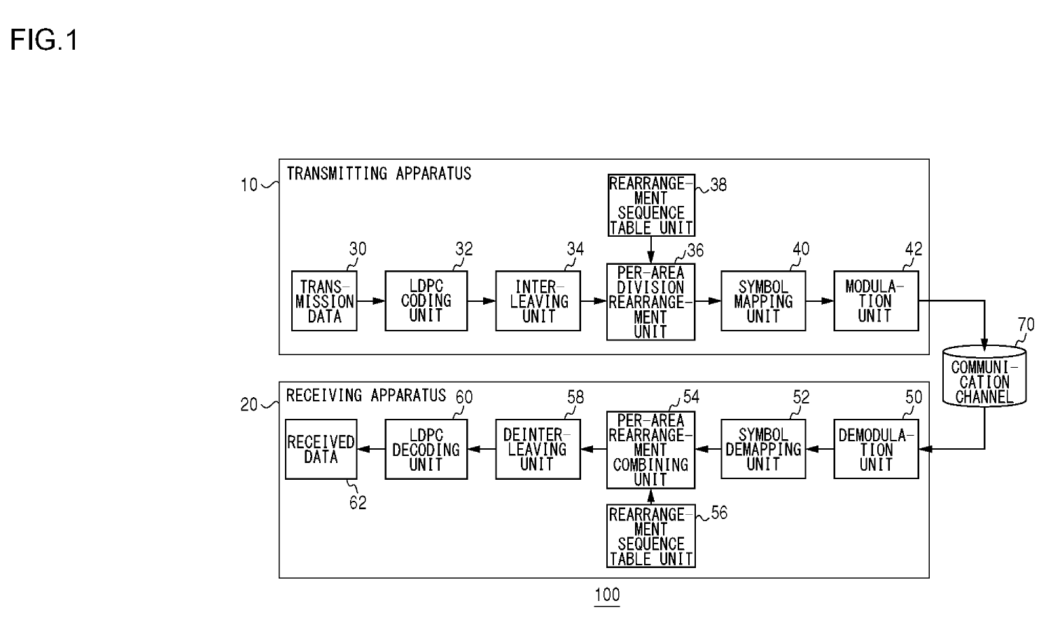

FIG. 1 shows a structure of a communication system 100 according to an exemplary embodiment of the present invention. The communication system 100 includes a transmitting apparatus 10, a communication channel 70, and a receiving apparatus 20. The transmitting apparatus 10 includes transmission data 30, an LDPC coding unit 32, an interleaving unit 34, a per-area division rearrangement unit 36, a rearrangement sequence table 38, a symbol mapping unit 40, and a modulation unit 42. The receiving apparatus 20 includes a demodulation unit 50, a symbol demapping unit 52, a per-area rearrangement combining unit 54, a rearrangement sequence table 56, a deinterleaving unit 58, an LDPC decoding unit 60, and received data 62.

The transmission data 30 is inputted to the LDPC coding unit 32. The transmission data 30 is data to be transmitted. The LDPC coding unit 32 receives the transmission data 30 and performs low density parity check (LDPC) coding on the transmission data 30. The LDPC coding unit 32 appends parity bits to the transmission data 30, based on a parity check matrix in the LDPC. In the LDPC coding, a parity check matrix having a low density generation matrix (LDGM) structure, for instance, is used.

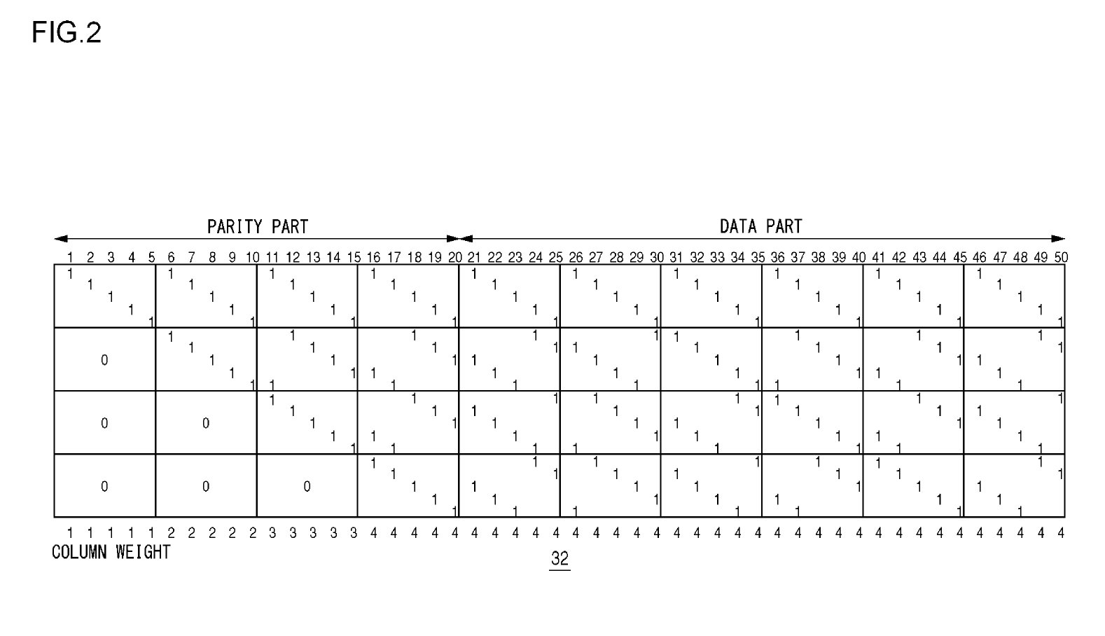

FIG. 2 shows a check matrix used in the LDPC coding unit 32 and the LDPC decoding unit 60. The parity check matrix having the LDGM structure is constructed such that the lower left triangular elements in a parity bit part of the parity check matrix are “0's”. According to this construction, the parity bits are computed in turn starting from an upper-order parity and therefore a generator matrix is identical to the parity check matrix. Note that the parity check matrix having the LDGM structure is not limited to that shown in FIG. 2 and may be a matrix constructed such that the upper left triangular elements are “0's” or the double diagonal elements are “0's”, for instance. When the LDPC coding is performed using a matrix of the LDGM structure, the column weight of a parity part (i.e., the number of “l's” in each column in the check matrix) is small and therefore the belief propagation in the parity part deteriorates as compared with that in a data part. As a result, the error correction capability deteriorates. Now, refer back to FIG. 1.

The interleaving unit 34 performs interleave processing according to the number of bits, which have been symbol-mapped by the symbol mapping unit 40, and the modulation multi-level number in the symbol mapping unit 40. A description is here given of a case where the symbol mapping unit 40 uses an 8-level frequency shift keying (FSK). Note that the symbol mapping is not limited to the eight levels. Also, PSK (Phase Shift Keying), QAM (Quadrature Amplitude Modulation) or the like may be used as the modulation scheme.

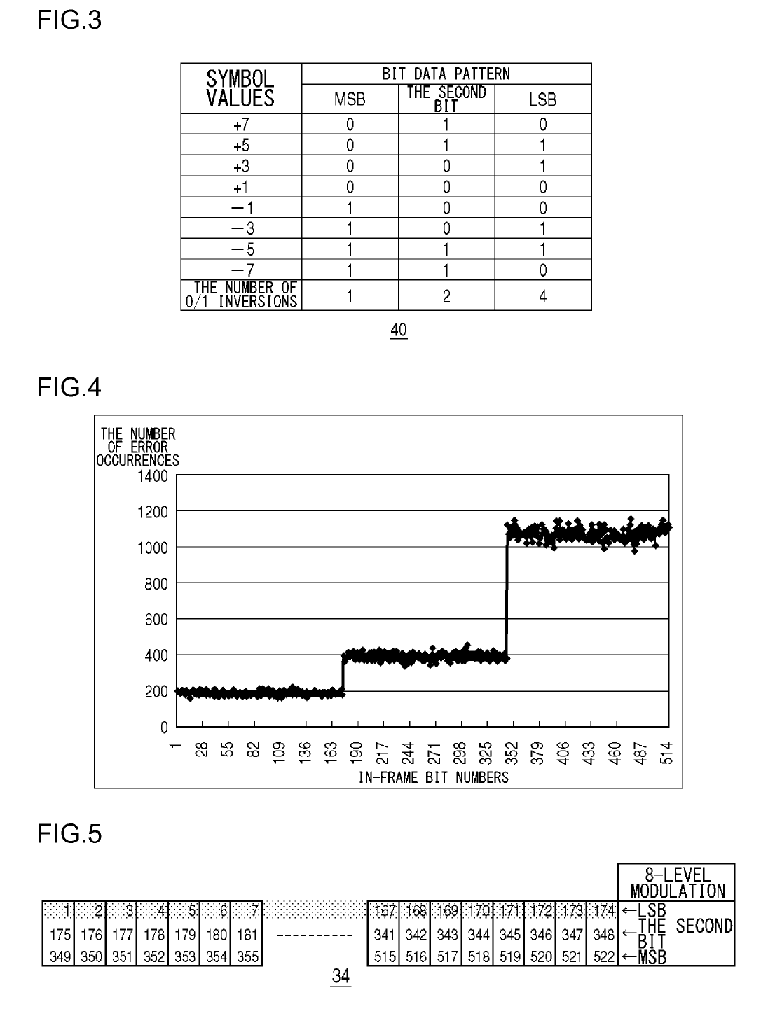

FIG. 3 shows a concrete example of a symbol mapping table in the symbol mapping unit 40. The symbol mapping unit 40 generates a symbol for every 3 bits. In this mapping, the number of inversions of “0” and “1” (hereinafter referred to as “the number of 0/1 inversions” also) changes depending on the bit position. Gray codes are used in the exemplary mapping of FIG. 3. In this example of FIG. 3, the number of 0/1 inversions is one time in the most significant bit (MSB), whereas it is four times in the least significant bit (LSB). FIG. 4 shows an exemplary frequency of error occurrence for each bit, which constitutes a symbol, based on the symbol mapping table. As shown in FIG. 4, the LSB for which the number of inversions is large is more susceptible to the noise than the MSB for which the number of inversions is small and therefore such the LSB is more susceptible to the noise than such the MSB does. Hence, the error is more likely to occur. Now, refer back to FIG. 1.

To cope with this problem, the interleaving unit 34 performs interleave processing. FIG. 5 shows a concrete example of a bit-interleaved array structure in the interleaving unit 34. As illustrated in FIG. 5, three rows of array of data are prepared in line with 3 bits that are to be symbol-mapped, and the interleaving unit 34 arranges in sequential order the data coded by the LDPC coding unit 32. Assume herein that the data for each coded frame is comprised of 522 bits.

As the coding is carried out using a parity check matrix having an LDGM structure, a parity bit part whose column weight is small and whose error correction capability is low is represented by bits 1 to 174. The interleave processing is performed such that this parity bit part, whose column weight is small and whose error correction capability is low, is arranged in the LSB. As already mentioned, LSB corresponds to bits where error is likely to occur in the 8-level FSK modulation. In other words, the interleaving unit 34 interleaves the data, which has been LDPC-coded by the LDPC coding unit 32, based on an array of data in line with the number of bits that constitute a modulated symbol.

Assume that the interleaving is done as described above and then the data is mapped, for every 3 bits along the column direction, in order from the left end. Assume also that the unit matrix size of a parity check matrix having the LDGM structure is of 29 bits. Then the column weight of bits 1 to 29 in the parity bit part arranged in the LSB bits in the FSK modulation is “1”. Further, those bits are transmitted continuously. In this case, the parity bit parts having the same column weight are lost all together due to the fading. Refer back to FIG. 1.

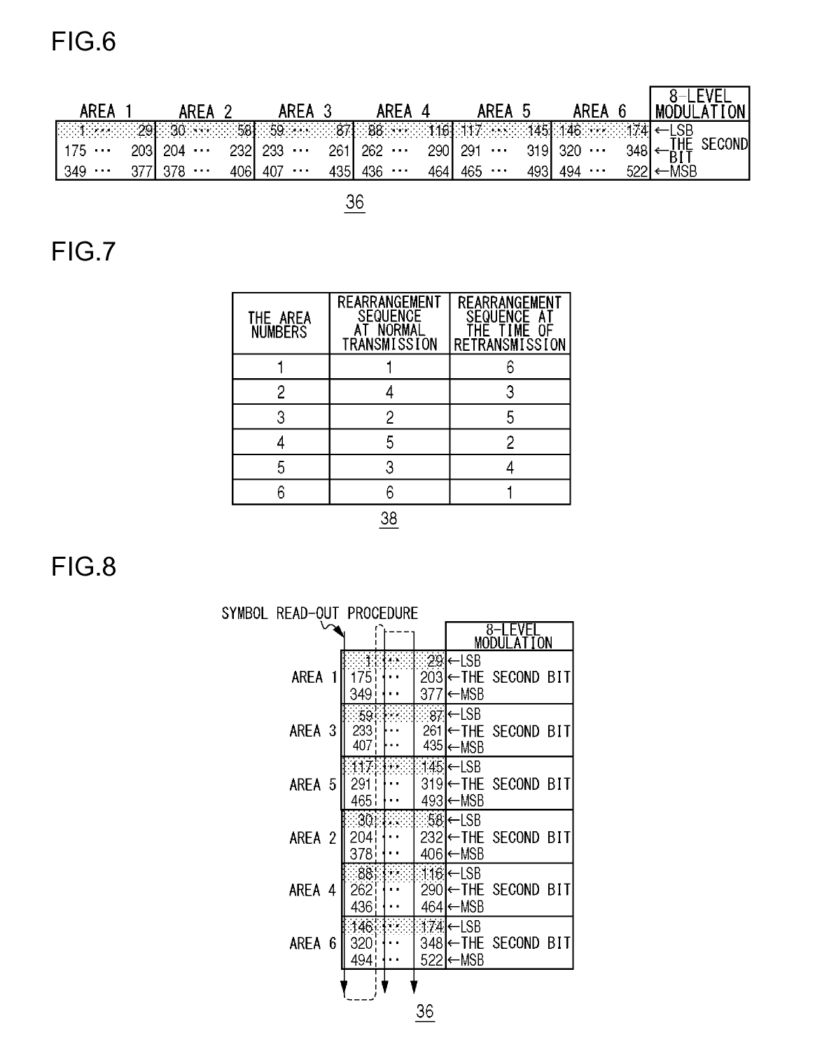

To cope with this problem, the per-area division rearrangement unit 36 divides the array data of 3 rows×174 columns, which has been generated by the interleaving unit 34, into a plurality of areas. FIG. 6 shows areas defined by the per-area division rearrangement unit 36. Here, the number of areas is “6”. The division number used herein is set to an integral multiple of a value wherein the value is obtained when the number of symbols for a single frame is divided by the unit matrix size of the parity check matrix having the LDGM structure. For example, the number of symbols for one frame is “174” symbols; the unit matrix size of the parity check matrix is of “29” bits; and the value is “6”, which is a result of 174 divided by 6. Here, the division number 6 is a value obtained when 6 is multiplied by 1. In other words, the per-area division rearrangement unit 36 divides or partitions to classify the data, which has been interleaved by the interleaving unit 34, into a plurality of areas in a manner such that each area is formed by contiguous data.

The rearrangement sequence table 38 determines the order in which the per-area division rearrangement unit 36 outputs the data from the plurality of areas. FIG. 7 shows a concrete example of the rearrangement sequence table 38. The “rearrangement sequence at normal transmission” is used here. Refer back to FIG. 1. The per-area division rearrangement unit 36 loads the rearrangement sequence table 38 and outputs the data in the order specified by the rearrangement sequence table 38. FIG. 8 shows an outline of processing carried out by the per-area division rearrangement unit 36. Here, the per-area division rearrangement unit 36 follows the “rearrangement sequence at normal transmission” of FIG. 7. In other words, while successively changing the areas, the per-area division rearrangement unit 36 outputs the data according to the number of bits that constitute a modulated symbol. In FIG. 8, the number of bits that constitutes the modulated symbol corresponds to “3”. Refer back to FIG. 2.

The per-area division rearrangement unit 36 rearranges the array of data, which has been divided into areas as illustrated in FIG. 8, and then outputs the bit data to the symbol mapping unit 40 for every 3 bits in order starting from the top left. Such processing as this enables bits 1 to 29, whose column weight is “1” in the parity bit part, for instance, to be transmitted once in every 6 symbols and therefore the continuous transmission is avoided. Note that the per-area division rearrangement unit 36 changes the order in which the areas are successively varied, when normal transmission is made and when retransmission is made, respectively. Here, the “rearrangement sequence at the time of retransmission” of FIG. 7 is used when retransmission is made.

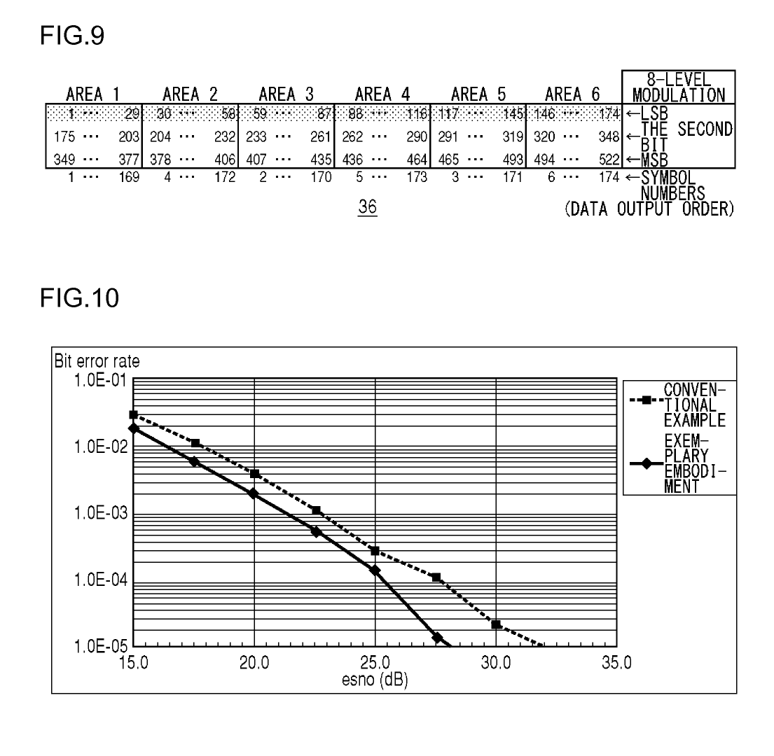

FIG. 9 shows another outline of processing carried out by the per-area division rearrangement unit 36. As shown in FIG. 9, the bit data may be transmitted to the symbol mapping unit 40 for each area, in order from the beginning, according to the table of the rearrangement sequence table 38, without the array of data divided into the areas being rearranged. Refer back to FIG. 1.

The symbol mapping unit 40 generates modulated symbols, based on the data fed from the per-area division rearrangement unit 36. That is, the symbol mapping unit 40 converts 3-bit data into a symbol value according to the symbol mapping table shown in FIG. 3 and then outputs its result to the modulation unit 42. The modulation unit 42 performs a predetermined modulation processing on the symbol data fed from the symbol mapping unit 40 so as to transmit the data. As mentioned earlier, 8-FSK is used here. The thus modulated signals are frequency-converted into radiofrequency signals and then the radiofrequency signals are transmitted to the communication channel 70.

The receiving apparatus 20 receives the signals sent from the transmitting apparatus 10 over the communication channel 70. Note that, in the transmitting apparatus 10 that generates the modulated symbols received by the receiving apparatus 20, the order in which the areas are successively varied is changed when normal transmission is made and when retransmission is made, respectively. Here, the receiving apparatus 20 carries out the processings, performed by the transmitting apparatus 10, in the reverse order. The demodulation unit 50 demodulates the received modulated symbols and outputs the demodulation result to the symbol demapping unit 52.

The symbol demapping unit 52 extracts data from the modulated symbols that have been demodulated by the demodulation unit 50. At this stage, the symbol demapping unit 52 converts the symbol values into soft-input values fed from the symbol mapping table of FIG. 3 so that the level of reliability for the bit data can be verified. Known art can be used for the conversion and therefore the description thereof is omitted here.

The per-area rearrangement combining unit 54 performs (i) a process, of dividing the data extracted by the symbol demapping unit 52 into a plurality of areas, performed in the per-area division rearrangement unit 36 of the transmitting apparatus 10 and (ii) a process, of outputting the data by successively changing the areas, performed in the per-area division rearrangement unit 36 of the transmitting apparatus 10, on the data extracted by the symbol demapping unit 52 in a reverse order, respectively. As a result, the per-area rearrangement combining unit 54 combines the data that has been divided for each area. More specifically, the per-area rearrangement combining unit 54 prepares the array of data such as that shown in FIG. 8. The sizes (i.e., the number of rows and number of columns) of the array of data prepared may be determined as follows.

[The number of rows]=[The number of bits that have been turned into symbols]×[The number of areas divided]

[The number of columns]=[The number of bits for each frame]/{[The number of bits that have been turned into symbols]×[The number of areas divided]}

The per-area rearrangement combining unit 54 puts the bit data, sent from the symbol demapping unit 52, into the array of data in order starting from the top left. As the data for one column has been inputted, the per-area rearrangement combining unit 54 puts the data in order starting from the top of the second column. As all data for one frame has been completely inputted, the per-area rearrangement combining unit 54 loads the rearrangement sequence table 56 as shown in FIG. 7 and then divides the data for each area according to the rearrangement sequence and combines the data as shown in FIG. 6. If the retransmission has been made, the “rearrangement sequence at the time of retransmission” of FIG. 7 will be used in the per-area rearrangement combining unit 54. That is, while changing the order according to the change in the order at the transmitting apparatus 10, the per-area rearrangement combining unit 54 combines the data that has been divided for each area.

The deinterleaving unit 58 deinterleaves the data, fed from the per-area rearrangement combining unit 54, in response to the interleaving performed by the transmitting apparatus 10. More specifically, the deinterleaving unit 58 outputs the array of data as shown in FIG. 5 to the LDPC decoding unit 60 in order of 1 to 522 from the top left along the row direction.

The LDPC decoding unit 60 LDPC-decodes the data deinterleaved by the deinterleaving unit 58. For example, a min-sum algorithm is executed in the LDPC decoding processing. The min-sum algorithm is carried out using the following procedures 1 to 3.

1. Initialization: A priori value ratio is initialized and the maximum number of decoding iterations is set.
2. Check node processing: An extrinsic value ratio is updated along the column direction of a check matrix.
3. Variable node processing: The priori value ratio is updated along the column direction of the check matrix.
4. A tentative estimation word is computed.

The LDPC decoding unit 60 outputs the result of decoding as the received data 62.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

FIG. 10 shows a result of simulation run in the communication system 100. This corresponds to a performance assessing result in the LDPC codes of 4-level FSK. As evident from FIG. 10, the performance in the exemplary embodiment where the data is divided into areas and is rearranged is improved over a conventional practice of no division into areas.

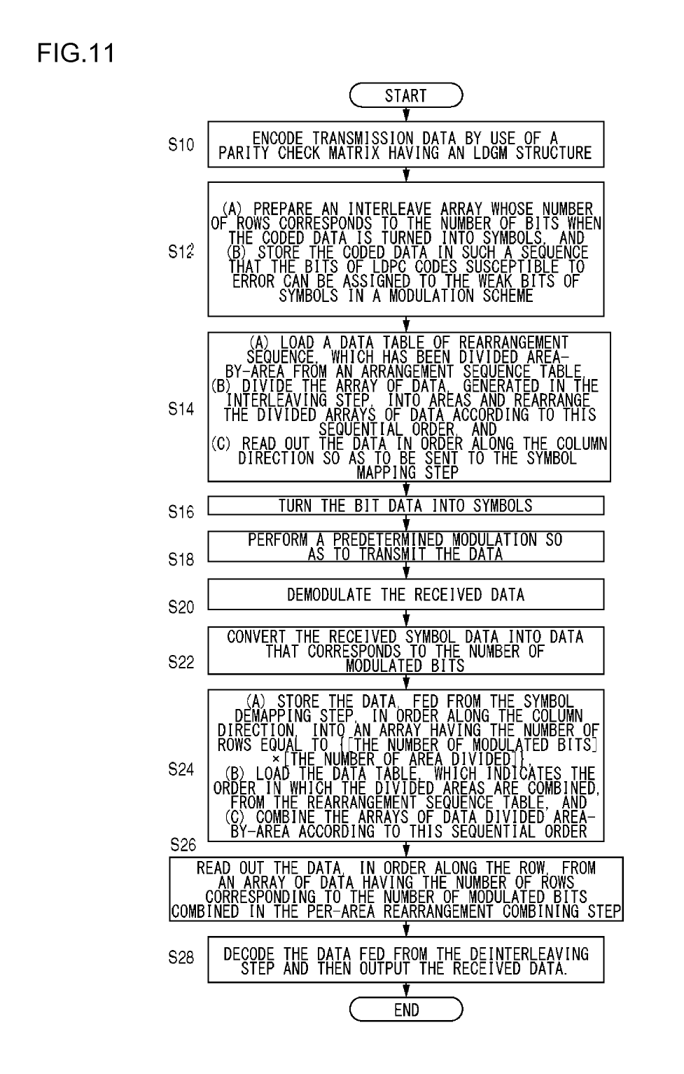

An operation of the communication system 100 configured as above is now described. FIG. 11 is a flowchart showing a communication procedure done by the communication system 100. In a first step of LDPC coding at transmission, transmission data is coded with a parity check matrix having an LDGM structure and then the coded data is fed to an interleaving step (S10). In the interleaving step, prepared is an interleave array whose number of rows corresponds to the number of bits when the coded data is turned into symbols. The coded data is stored in sequential order such that the bits of LDPC codes susceptible to error can be assigned to the weak bits of symbol data in a modulation scheme (S12).

In the next step of per-area division rearrangement, the data table of rearrangement sequence in a divided area is loaded from the rearrangement sequence table. The array of data generated in the interleaving step is divided into areas and then rearranged according to this sequential order. Then, the data is read out in order along the column direction and the thus read-out data is sent to a symbol mapping step (S14). In the symbol mapping step, the bit data is turned into symbols so as to be sent to a modulation step (S16). In a modulation step, a predetermined modulation is performed on the symbols and then the modulated data is transmitted (S18).

In the next step of demodulation at receiving, the received data is demodulated and the thus demodulated data is sent to a symbol demapping step (S20). In the symbol demapping step, the received symbol data is converted into data that corresponds to the number of modulated bits (S22). In a step of per-area rearrangement combining, the data fed from the symbol demapping step is stored in order along the column direction into an array having the number of rows equal to {[The number of modulated bits]×[The number of areas divided]}. The data table, which indicates the order in which the divided areas are combined, is loaded from the rearrangement sequence table; the arrays of data divided area-by-area are combined according to this sequential order (S24).

In the next deinterleaving step, the data is read out, in order along the row, from an array of data having the number of rows corresponding to the number of modulated bits that have been combined in the per-area rearrangement combining step, and then the thus read-out data is sent to an LDPC decoding step (S26). In the LDPC decoding step, the data sent from the deinterleaving step is decoded and the receive data that has been decoded is outputted (S28).

According to the exemplary embodiments of the present invention, the parity bit parts of LDPC codes whose column weights are small and which are susceptible to error are assigned to the LSB bit of modulated symbols susceptible to noise. Thus, a main data part can be assigned in a position resistive to noise. Since the main data part is assigned in the position robust against noise, the error correction capability can be enhanced. Also, the interleaved array of data is divided area-by-area and rearranged. Such a very simple processing as this prevents the parity bits having the same column weight from being transmitted continuously, thereby preventing the parity bit parts having the same column weight from being lost all together. Since the data loss of those having the same column weight all at once is suppressed, the error correction capability can be improved. Also, the order, in which the areas are successively varied, are changed when normal transmission is made and when retransmission is made, respectively. Thus, the error patterns can be varied between when normal transmission is made and when retransmission is made.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

In the exemplary embodiments of the present invention, it is presupposed that the communication system 100 is a radio communication system and therefore the transmitting apparatus 10 and the receiving apparatus 20 are both included in a radio communication apparatus. However, this should not be considered as limiting and, for example, the communication system 100 may be a wired communication system. In that case, the transmitting apparatus 10 and the receiving apparatus 20 are both included in a wired communication apparatus. According to this modification, the exemplary embodiments may be applicable to a variety of apparatuses.

What is claimed is:

1. A transmitting apparatus comprising:
a low density parity check (LDPC) coding unit configured to perform LDPC coding;
an interleaving unit configured to interleave data that has been LDPC-coded by the LDPC coding unit, based on an array according to the number of bits that constitute a modulated symbol;
a per-area division rearrangement unit configured to divide the data, which has been interleaved by the interleaving unit, into a plurality of areas in a manner such that each area is formed by contiguous data and configured to output data, according to the number of bits that constitute the modulated symbol, by successively changing the areas; and
a mapping unit configured to generate the modulated symbol based on the data fed from the per-area division rearrangement unit.

2. A transmitting apparatus according to claim 1, wherein, the per-area division arrangement unit changes the order in which the areas are successively varied, when normal transmission is made and when retransmission is made, respectively.

3. A receiving apparatus comprising:
a receiver configured to receive a modulated symbol from a transmitting apparatus, wherein the transmitting apparatus (1) interleaves data on which low density parity check (LDPC) coding has been performed, based on an array according to the number of bits that constitute a modulated symbol, (2) divides the interleaved data into a plurality of areas in a manner such that each area is formed by contiguous data and outputs data, according to the number of bits that constitute the modulated symbol, by successively changing the areas, and (3) generates the modulated symbol based on the data outputted;
a demapping unit configured to extract data from the modulated symbol received by the receiver;
a per-area rearrangement combining unit configured to combine the data, which has been divided for each area, in a manner such that (i) a process, of dividing into a plurality of areas, performed in the transmitting apparatus and (ii) a process, of outputting the data by successively changing the areas, performed in the transmitting apparatus are performed on the data extracted by the demapping unit in a reverse order, respectively;
a deinterleaving unit configured to deinterleave the data, fed from the per-area rearrangement combining unit, in response to interleaving performed by the transmitting apparatus; and
an LDPC decoding unit configured to LDPC-decode the data that has been deinterleaved by the interleaving unit.

4. A receiving apparatus according to claim 3, wherein the transmitting apparatus for generating the modulated symbol received by the receiver changes the order in which the areas are successively varied, when normal transmission is made and when retransmission is made, respectively, and
wherein the per-area rearrangement combining unit combines the data, which has been divided for each area, by changing the order according to a change in the order at the transmitting apparatus.

5. A transmitting method comprising:
performing low density parity check (LDPC) coding;
interleaving data that has been LDPC-coded, based on an array according to the number of bits that constitute a modulated symbol;
dividing the interleaved data into a plurality of areas in a manner such that each area is formed by contiguous data and outputting data, according to the number of bits that constitute the modulated symbol, by successively changing the areas; and
generating the modulated symbol based on the data outputted.

6. A receiving method comprising:
receiving a modulated symbol from a transmitting apparatus, wherein the transmitting apparatus (1) interleaves data on which low density parity check (LDPC) coding has been performed, based on an array according to the number of bits that constitute a modulated symbol, (2) divides the interleaved data into a plurality of areas in a manner such that each area is formed by contiguous data and outputs data, according to the number of bits that constitute the modulated symbol, by successively changing the areas, and (3) generates the modulated symbol based on the data outputted;
extracting data from the modulated symbol received;
combining the data, which has been divided for each area, in a manner such that (i) a process, of dividing into a plurality of areas, performed in the transmitting apparatus and (ii) a process, of outputting the data by successively changing the areas, performed in the transmitting apparatus are performed on the extracted data in a reverse order, respectively;
deinterleaving the combined data in response to interleaving performed by the transmitting apparatus; and
performing LDPC-decoding on the interleaved data.
